(19) United States
(12) Patent Application Publication
(10) Pub. No.: US 2005/0023734 A1
(43) Pub. Date: Feb. 3, 2005

(54) Method for producing a component from fiber composite material

(76) Inventor: Martin Koschmieder, Stuttgart (DE)

Correspondence Address: PENDORF & CUTLIFF, 5111 Memorial Highway, Tampa, FL, 33634-7356, US

(21) Appl. No.: 10/847,505

(22) Filed: May 17, 2004

(30) Foreign Application Priority Data
May 17, 2003 (DE) 103 22 297.9

(51) Int. Cl. B29C 47/00; B29C 45/00; B29D 9/00

(52) U.S. Cl. 264/513

(57) ABSTRACT

The invention relates to a method for producing a partly hollow component (36) from a fiber composite material. In this case, a fusible core (4) is applied to a supporting core (6) by injection molding or casting. A reinforcing fiber (10) is then applied to the core (2). In the process, a fiber structure (14) is produced. The fiber structure (14) is impregnated with a resin. The fiber structure (14), together with the core (2), is put into a conveyor oven (18). During a continuous temperature process, first of all the resin is cured in order that the fiber structure (14) reaches a dimensionally stable state, and then the fusible core material is melted out of the core (2). The supporting core (6) is then removed from the component (36).

### BACKGROUND OF THE INVENTION

1. Field of Invention

The invention relates to a method according to the features of claim 1.

2. Related Art of the Invention

In the Japanese patent application JP 081 84 128 A, the production of a fiber reinforced structure component is described. In this case, this is a hollow chamber profile which is provided with a plurality of layers of fibers. It is possible to configure the hollow chamber profile with a plurality of subdivided cavities. However, JP 081 84 123 A leaves open the question of the extent to which such a hollow profile can be produced in a manner suitable for mass production.

DE 197 36 573 A1 likewise describes a method for producing fiber composite materials. In this case, the matrix is represented by thermoplastic matrix plastics. Endless fibers are wound onto a core and impregnated with thermoplastic resins. According to DE 197 36 573 A1, the core onto which the endless fibers are wound is composed of metal, plastic or glass. Cores of this type are substantially hard and dimensionally stable, so that they cannot be removed from a component if this component has undercuts. In addition, in the aforementioned patent application, solid starting materials are used for the fiber reinforced plastic and can be introduced into the fiber structure only after being dissolved in a solvent. The solvent has to be removed again following the impregnation of the fiber structure, so that complicated measures are required for health and safety and environmental protection. In addition, DE 197 36 573 A1 leaves open the question as to how the formation of porosity as a result of driving out the solvent is prevented.

EP 1 109 657 B1 describes a method in which fibers and resin are applied to a core, the core containing a filler which is removed after the fiber structure has been cured. However, EP 1 109 657 B1 does not describe any reliable-process production method for such components which is suitable for mass production.

### SUMMARY OF THE INVENTION

The object of the invention is to provide a method for producing fiber composite materials with a matrix of thermosetting plastic and with which the implementation of undercuts can be realized. In addition, the method is to be economical and to guarantee high process reliability.

The achievement of the object consists in a method as claimed in the features of patent claim 1.

The method according to the invention for producing a fiber composite material comprises the following steps. A fusible core is applied to a supporting core in an injection molding method or by means of a casting method. Reinforcing fibers are applied to this core, a fiber structure being produced. The application of the fiber structure can be carried out, for example, by fiber winding or inter-weaving. For this purpose, a suitable winding or inter-weaving machine is used.

If appropriate, the fiber structure is impregnated with a curable resin before being applied to the core. In this case, a curable resin is understood to mean a thermosetting base material comprising a mixture of a resin and a hardener and, if appropriate, additives. A composite produced in this way from the core and the fiber structure impregnated with resin is put into a conveyor oven. Here, in a continuous process, in a first temperature step the resin is cured to such an extent that the composite exhibits adequate dimensional stability. In a second temperature step, the fusible core is melted out of the composite. In this case, only the supporting core remains in the composite. The supporting core is then withdrawn from the component now produced in this way.

The advantage of the method of the invention is that it is a continuous process. The composite comprising fiber structure and core can be put directly into a conveyor oven following impregnation and winding and can be cured to form the component. The advantage in this is that the composite does not have to be stored. This in turn leads to the impregnated resin remaining in the fiber structure and not being able to drip out as a result of relatively long storage. Furthermore, a reproducible course of the reaction of the resin in mass production can be ensured in this way. This in turn results in considerable quality advantages.

A further advantage of the method of the invention is that a combined core comprising a fusible core and a supporting core can be used in such a way that undercuts in the component can be realized. This is realized by the fact that regions which form such undercuts are represented by a fusible core and are melted out before the supporting core is removed.

In a further embodiment of the invention, after being melted out, the material of the fusible core can be supplied to the injection molding process or the casting process again. The advantage here is that operating materials can be saved, which makes the method more economical.

In a preferred refinement, the fusible core consists of a wax. Wax has the advantage that it has a relatively low melting temperature and can be melted out of the component without excessive thermal stresses on the latter.

The material of the molten core can be steered in the conveyor oven in such a way that it drips onto a conveying device and is transported away out of the oven region. The wax recovered in this way can then be supplied to the core production again.

For the purpose of melting out the fusible core material, in a preferred embodiment the supporting core can be configured to be hollow. In this case, the supporting core has openings, into which the molten core material flows and can run away outside the component through a further opening in the supporting core.

In this case, means can be provided by means of which the molten core material is shaped into droplets or pellets. The means of this kind can, for example, be configured in the form of a screen or perforated plate. The fusible core material flows through the openings in these means, cools and forms droplets or pellets. Pellets of this type are particularly well suited to be used for the injection molding process.

In this case, the aforesaid means for forming pellets can be fitted between the component and the conveying device. In one embodiment, the means for forming the pellets are fitted to a lower opening of the supporting core. This can be done, for example, by fitting a perforated plate to the outlet opening of the supporting core.

The impregnation of the fiber structure with the resin can already be carried out by impregnating the reinforcing fiber before applying to the core. In this case, the reinforcing fiber is, for example, deflected through a resin bath before the winding process. On the other hand, it is possible to impregnate the composite comprising fiber structure and core in a resin bath after the winding of the reinforcing fiber. Both possible ways of impregnating with the core can be carried out either on their own or one after the other in combination.

Depending on the viscosity and flow behavior of the resin, the resin can be pre-gelled after the impregnation of the reinforcing fiber before or after the application to the core. This is understood to include pre-curing which, for example, can be carried out by means of UV irradiation.

In a further embodiment of the invention, a plurality of composites comprising core and fiber structure are assembled to form a multi-chamber profile. This multi-chamber profile is in turn surrounded with a fiber structure. The assembly of the individual composites can be carried out before or after the impregnation and before or after pre-gelling of the resin.

Wrapping aids can be arranged on the core, which permit slippage-free positioning of the reinforcing fibers on the core and which, in a preferred embodiment, are integrated directly in the core. These wrapping aids can be constituted in the form of burrs or knobs, for example. These knobs can already be integrated at the same time as the injection molding of the fusible core. In this case, these knobs can consist either directly of resin or, for example, of metal.

In an optional intermediate step, the composite comprising fiber structure and core can be calibrated in a calibration mold after the impregnation of the resin and before the introduction into the conveyor oven. As a result, dimensional stability and a particularly high surface quality can be achieved.

### BRIEF DESCRIPTION OF THE DRAWINGS

Preferred embodiments of the invention will be explained in more detail by using the following drawings, in which:

FIG. 1 shows a core comprising a supporting core and a core of fusible material,

FIG. 2 shows a schematic illustration of a winding machine in which a plurality of cores are simultaneously provided with a fiber structure,

FIG. 3 shows an illustration of a calibration mold, in which a composite comprising fiber structure and core is inserted,

FIG. 4 shows a schematic illustration of a conveyor oven with a plurality of composites comprising fiber structure and core,

FIG. 5 shows an enlarged illustration of the detail FIG. 5 from FIG. 4, with a supporting core and an outlet opening for fusible material,

FIG. 6 shows a composite comprising fiber structure and core, in which the core is open at an underside and the fusible material is flowing out,

FIG. 7 shows a component from which wax has already melted out and the supporting core is being withdrawn,

FIGS. 8a-c show the production of a multi-chamber profile by laying together a plurality of composites comprising fiber structure and core,

FIG. 9 shows an illustration of a component with a multi-chamber profile.

### DETAILED DESCRIPTION OF THE INVENTION

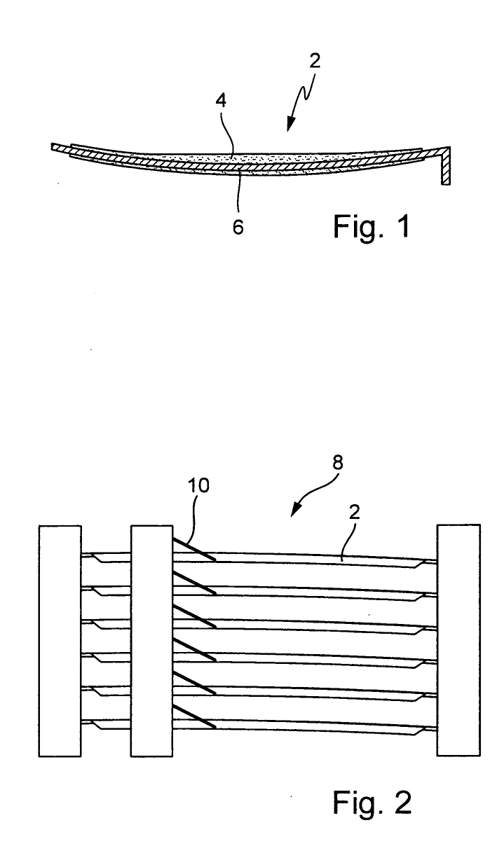

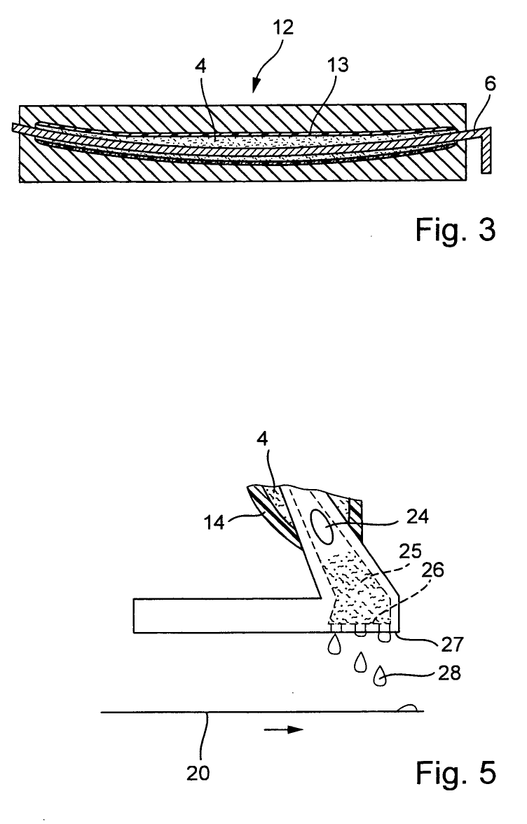

In FIG. 1, a core 2 which comprises a supporting core 6 and a core 4 of fusible material is illustrated. In order to produce the core 2, the supporting core 6 is inserted into an injection molding machine and encapsulated with a wax. The supporting core 6 can usually comprise a steel tube or an aluminum tube. It should be noted here that the supporting core 6 is of curved configuration. In the case of a solid core of metal, glass or plastic, such a shape could not be removed from a component 36 without destruction.

A core 2 of this type can be fitted to a suitable winding machine 8 together with a plurality of identical cores. A winding machine 8 is illustrated schematically in FIG. 2. In this case, a plurality of cores 2 are simultaneously provided with a reinforcing fiber 10. As an option, it may be expedient to provide the reinforcing fiber 10 with resin in a dip bath, not illustrated here. This leads to the fiber structure 14 already being impregnated with resin after winding. Depending on the absorption capacity of the fibers 10 for resin, it may then be necessary to put the composite 16 comprising fiber structure 14 and core 2 subsequently into a dip bath. Both impregnation methods can be used individually or jointly one after the other. The application of this method and its combination depends on how much resin the fiber or the fiber structure can take up and how much resin is needed. The fibers used are preferably carbon fibers, aramide fibers or glass fibers.

In the case of particularly low-viscosity resins or in the event that there is a need for short-term storage, the resin can be pre-gelled following the impregnation. The pre-gelling is produced either by means of UV radiation or by means of microwaves or by means of a temperature treatment. As a result, the ability of the resin to flow is reduced and the impregnated reinforcing fiber or the composite comprising impregnated fiber structure and core can be handled better.

In order to produce particularly high-quality surfaces, the composite 16 comprising impregnated fiber structure 14 and core 2 can be put into a calibration mold 12. The calibration mold 12 is preferably heated, normally to temperatures around 60°. At this temperature, the fusible core 4 (wax core) expands thermally and presses the fiber structure 14 (laminate) against the wall of the mold. Any surface irregularities which may be present are evened out in this way. The calibration mold is expediently designed in such a way that a plurality of composites comprising impregnated fiber structure and core can be calibrated at the same time.

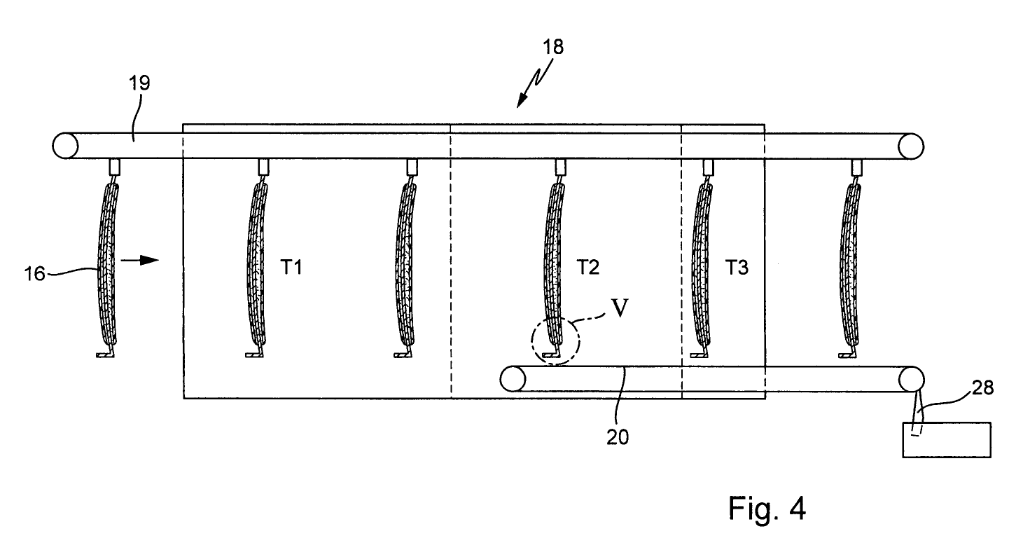

The composite 16 comprising fiber structure 14 and core 2 is then put into a conveyor oven 18. The composite 16 can, for example, be fixed to a conveying device 19, as illustrated in FIG. 4. The conveying device 19 conveys the composite 16 through the conveyor oven 18. The conveyor oven 18 has substantially two temperature zones. The temperature zone T1 lies in a temperature range between 60° C. and 80° C. In this temperature range of the temperature zone T1, the resin is cured to such an extent that the fiber structure 14 has a dimensional stability that is adequate for the further method. The composite 16 is then led into the second temperature zone T2. T2 comprises a temperature which is higher than the temperature T1. At the temperature T2, the wax of the fusible core 4 is melted out.

In an embodiment according to FIG. 5, the fiber structure 14 rests directly on the supporting core 6 in the lower region, is internally hollow and has openings 24. Liquid wax 25 from the fusible core 4 passes through the openings 24 into a cavity in the supporting core 6 and flows away downward. A lower opening 27, into which a nozzle opening 26 is introduced, is provided at the lower end of the supporting core 6. The nozzle opening 26 can, for example, comprise a perforated plate or a screen. The wax flows through the nozzle opening 26 and, in the process, is shaped into droplets, the droplets fall onto a conveying device 20 and solidify. The solidification of the droplets 28 can take place either during the flight or on the conveying device 20. The solidified droplets 28 are designated pellets. The pellets 28 then already have the ideal shape to be able to supply them to the injection molding process or further conditioning again.

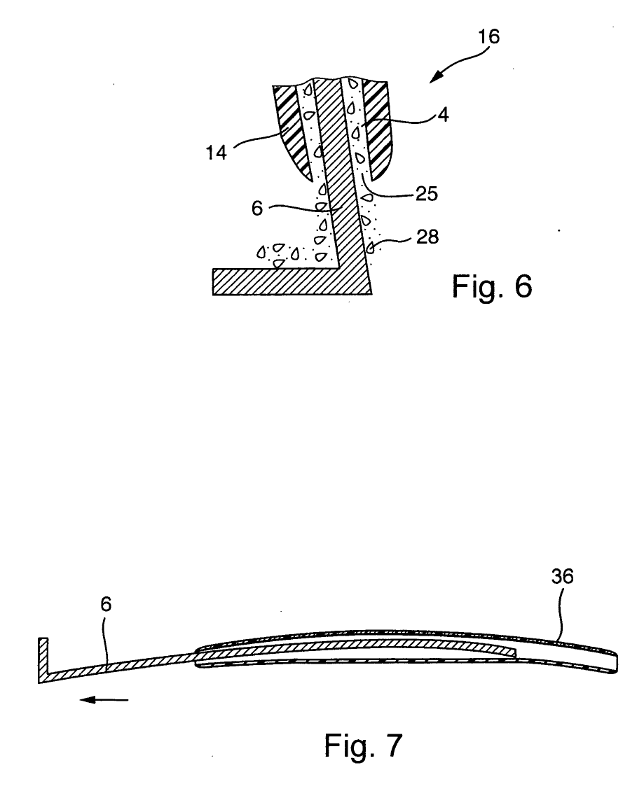

In a further embodiment of the invention according to FIG. 6, the composite 16 comprising core 2 and fiber structure 14 is configured in such a way that, in the lower region of the core 2, the fiber structure 14 does not rest directly on the supporting core 6 but on the fusible core 4. In this configuration, the molten material of the fusible core 4, as a rule the liquid wax 25, does not flow away through the supporting core 6 but runs downward along the supporting core. After the wax has been melted out, the already (at least partly) cured fiber structure 14 maintains its shape, as illustrated in FIG. 6. The wax which runs away on the supporting core 6 is collected, for example, in a trough not illustrated here. The trough can perform the same function as the nozzle opening 26 from FIG. 5. In this case, the trough can likewise be provided with a perforated plate and a screen, through which the liquid wax drips onto a conveying device. This measure also produces pellets 28, which can be supplied to the injection molding process again.

As an alternative to the conveying device 20, the pellets can be led away to the outside through an opening in the lower region of the conveyor oven 18, for example through a funnel-like opening.

Should it be necessary to carry out a further temperature step, because of the chemical composition and the reaction behavior of the resin, after the wax has been melted out, the composite 16 can be cured finally in a third temperature zone T3. The temperature zone T3 is normally higher than the melting temperature of the wax in the temperature zone T2. Depending on the composition of the composite 16, the entire oven process can last between one hour and 36 hours. The oven passage time is usually 6-8 hours.

The cured fiber structure 14 will be designated the component 36 in the following text. The component 36 with the remaining supporting core leaves the conveyor oven 18. It is removed from the conveying device 19 and the supporting core 6 is withdrawn from the component 36. In the case of some geometric configurations of the component 36, it may be the case that the supporting core 6 cannot readily be removed from the component 36. In these cases, it may be expedient to cut off the ends of the component together with the supporting core 6, for example by means of oscillating sawing. The supporting core 6 can then be withdrawn from the component 36.

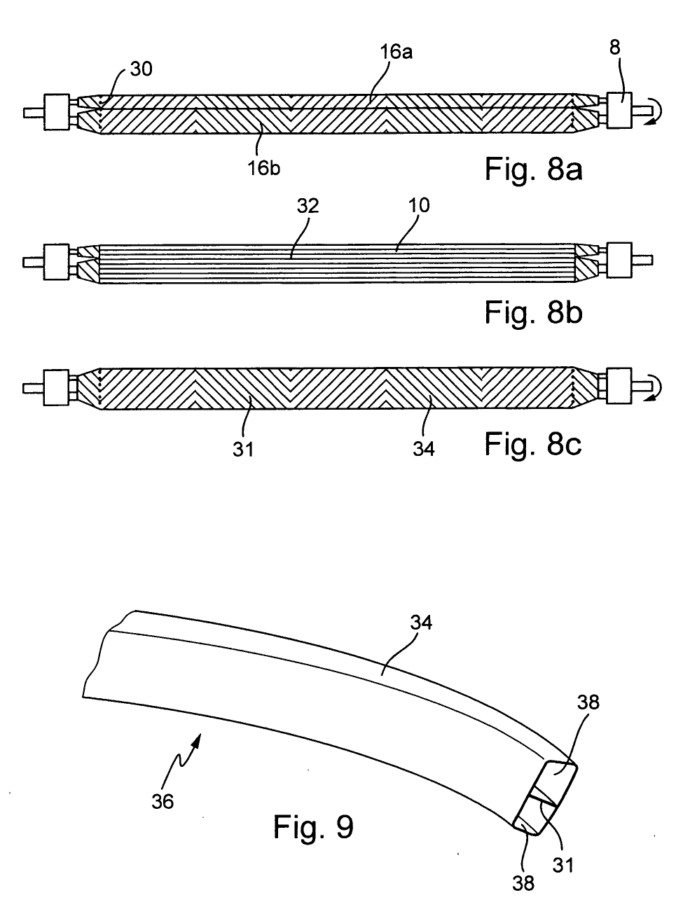

An embodiment of the invention which is likewise expedient is illustrated in FIGS. 8a-c. In this case, a plurality of composites 16 comprising core 2 and fiber structure 14 are arranged beside one another and in turn wrapped with a reinforcing fiber 10. In this case, the fiber structure can be impregnated or un-gelled and optionally also pre-gelled. Here, in FIG. 8b, a unidirectional intermediate layer 32 is provided. The unidirectional intermediate layer can comprise an impregnated reinforcing fiber in the pre-gelled state or a pre-impregnated reinforcing fiber (prepreg). The application of one or more cross layers, which form an outer layer 34, is then carried out. In order to apply the unidirectional layer 32 and the outer layer 34, it may be expedient to fit wrapping aids 30 directly to the core 2. The wrapping aids 30 can be represented, for example, by the insertion of a metal ring into an injection mold. The metal ring in this case remains in the core 2 following the injection molding. The metal ring has, for example, radial knobs or teeth, around which the fiber 10 can be wound. It is likewise possible to constitute knobs in the injection mold, which are filled with wax during injection molding and thus represent an integral constituent part of the core 2.

FIG. 9 illustrates a finished component 36 which has a multi-chamber profile 31 which is assembled from a plurality of cavities 38. The component 36 can, for example, be constituted as a rear bending beam or as a further bodywork component in an automobile.

1-13. (Cancelled)

14. A method for producing an at least partly hollow component from a fiber composite material, comprising the following steps:
(a) producing a combined core from a fusible core (4) and a supporting core (6),
(b) applying a reinforcing fiber (10) to the core (2) in order to create a fiber structure (14),
(c) impregnating the fiber structure (14) with a curable resin,
(d) introducing the composite (16) comprising core (2) and fiber structure (14) into a conveyor oven (18),
(e) in a continuous process, in a first temperature step, at least partially hardening the resin to produce a dimensionally stable state,
(f) in a second temperature step, melting the fusible core (4) out of the product of step (e) and
(g) removing the supporting core (6) from the component (36),
wherein, following step (c), the composite (16) is warmed in a calibration mold (12) so that the fusible core (4) expands thermally and presses the fiber structure (14) against the wall of the mold,
and wherein the production of the combined core (2) in (a) is carried out by means of injection molding or casting the fusible core (4) onto the supporting core (6).

15. The method according to claim 14, further comprising, supplying the fusible core (4), after melting out, back to the injection molding process or the casting process.

16. The method according to claim 14, wherein the material of the fusible core (4) is a wax.

17. The method according to claim 14, wherein the fusible core (4) drips onto a conveying device (20) and is transported away out of the oven region.

18. The method according to claim 14, wherein the supporting core (6) is hollow and, on its surface, has openings (24) through which the molten core material (25) can run away.

19. The method according to claim 14, wherein means (26) are provided via which the molten core material (25) is shaped into pellets (28) and solidifies.

20. The method according to claim 19, wherein the means (26) for forming pellets are fitted between the component and the conveying device (20).

21. The method according to claim 19, wherein the means (26) for forming pellets (28) are fitted to a lower opening (27) of the supporting core (6).

22. The method according to claim 14, wherein the impregnation of the fiber structure (14) with resin is carried out by impregnating the reinforcing fiber (10) before winding onto the core (2).

23. The method according to claim 14, wherein the impregnation of the fiber structure (14) with resin is carried out by impregnation after winding.

24. The method according to claim 14, wherein the resin (14) is pre-gelled by the action of energy after the impregnation of the reinforcing fiber and before being introduced into the conveyor oven (18).

25. The method according to claim 14, wherein a plurality of composites (16) comprising core (2) and fiber structure (14) are placed together and in turn wrapped to form a multi-chamber profile (31).

26. The method according to claim 14, wherein wrapping aids (30) are integrated in the core.
